(19) United States
(12) Patent Application Publication
(10) Pub. No.: US 2017/0105065 A1
(43) Pub. Date: Apr. 13, 2017

(54) PASSIVE RADIATOR WITH DYNAMICALLY ADJUSTABLE RESONANT FREQUENCY

(71) Applicant: Clean Energy Labs, LLC, Austin, TX (US)

(72) Inventor: Joseph F. Pinkerton, Austin, TX (US)

(73) Assignee: Clean Energy Labs, LLC, Austin, TX (US)

(21) Appl. No.: 15/289,579

(22) Filed: Oct. 10, 2016

Related U.S. Application Data
(60) Provisional application No. 62/239,684, filed on Oct. 9, 2015.

(51) Int. Cl. H04R 1/28; H04R 3/04; H04R 9/06; H04R 17/00

(52) U.S. Cl. CPC H04R 1/2834; H04R 17/00; H04R 3/04; H04R 9/06

(57) ABSTRACT

An audio speaker having one or more passive radiators, and more specifically, an audio speaker having a passive radiator with dynamically adjustable resonant frequency. The audio speaker can dynamically adjust the resonant frequency of its passive radiator so that it lines up with the main bass note frequency (or frequencies) of a given song.

### CROSS-REFERENCE TO RELATED PATENT APPLICATIONS

This application claims priority to provisional U.S. Patent Application Ser. No. 62/239,684, filed Oct. 9, 2015, entitled “Passive Radiator With Dynamically Adjustable Resonant Frequency,” which provisional patent application is commonly assigned to the Assignee of the present invention and is hereby incorporated herein by reference in its entirety for all purposes.

### TECHNICAL FIELD

The present invention relates to audio speakers having one or more passive radiators, and more specifically, audio speakers having passive radiators with dynamically adjustable resonant frequency.

### BACKGROUND

One goal in audio speaker design is the sound quality of the loudspeaker. There has been an effort to develop small/portable/bluetooth audio speakers. However, such smaller audio speakers typically sacrifice sound quality and/or frequency response due to their small size.

Audio speakers generally include an enclosure and at least one sound transducer, or active driver speaker, having a driver surface or diaphragm that produces sound waves by converting an electrical signal into mechanical motion of the driver diaphragm. An audible sound, or “sound wave,” is produced by periodic pressure changes propagated through a medium, such as air. Sound transducers, such as active driver speakers, typically generate sound waves by physically moving air at various frequencies. That is, an active driver speaker pushes and pulls a diaphragm in order to create periodic increases and decreases in air pressure, thus creating sound. High-frequency sounds have small wavelengths, and thus require only small, fast air pressure changes to be produced for a given perceived loudness.

On the other hand, low-frequency sounds have large wavelengths, and accordingly require large, slow air pressure changes for the same perceived loudness. The size of the pressure change is dependent on the amount of air the sound transducer or active driver speaker can move at a desired frequency.

In general, a small, lightweight diaphragm is efficient at producing high frequencies because it is small and comparatively lightweight, but may be inefficient at moving sufficient air to produce low frequencies. In contrast, a large diaphragm may be well suited for moving a large amount of air at low frequencies, but not fast enough to produce high frequencies efficiently. Thus, where space is available, many systems employ more two or more active driver speakers of different sizes in order to better achieve a flat frequency response across a wide frequency range.

The diaphragm of an active driver speaker vibrates in two directions, producing a sound wave at one side (front) of the diaphragm that is 180° degrees out of phase with a sound wave produced at the other side (rear). Since identical sound waves 180° out of phase cancel each other, a “baffle” or wall is employed to separate the front and back sound waves to prevent the rear sound wave from canceling the front sound wave. The baffle is incorporated into a box, as (an ideally) infinite-sized baffle is physically impractical. A “sealed box” system removes almost all effects of the rear sound wave. However, unless additional measures are taken, such a “sealed box” system inefficiently permits only half of the sound waves (i.e., the front sound waves) produced by the active driver speaker to be used.

One technique for improving sound quality and taking advantage of the sound waves produced at the rear of an active driver speaker, particularly at low frequencies, is to introduce one or more tuned ports through a wall (usually a front (baffle) or rear face) of the speaker enclosure. The port, also known as a duct or vent in a bass reflex system, is a passive device. That is, it does not receive an electrical signal as would an “active” device such as an active driver speaker. Each tuned port typically includes a cylindrical tube that penetrates the wall of the enclosure at one end and extends into the enclosure at the other end. Such a cylindrical tube has a cross-sectional area and length that together are configured or “tuned” to determine a range of frequencies at which the cylindrical tube may resonate and vent air, generally enhancing the lower frequencies and the overall sound reproduction in general. Much like when a person blows across the opening of a jug, the compression and rarefaction of air in the enclosure due to the active driver speaker's movement produces sound at the tuned port. The tuning of the port addresses the phase differences between the front and back sound waves and thus permits the rear sound wave to be utilized, thus increasing efficiency and enhancing the range of frequencies to which the port(s) are tuned. This permits enhanced response at the lower frequency range and/or permits use of active driver(s) that are less responsive at lower frequency due to size or quality.

Typical small/portable/bluetooth audio speakers use one or more active voice coil cone drivers (the two round elements in drawings below) and one or more “passive radiators.” The passive radiators are typically nothing more than weighted flexible diaphragms that have one or more mechanical resonant frequencies (that depend on their mass and stiffness). The cone drivers create an oscillating air pressure within the speaker chamber near the resonant frequency of the passive radiator(s) and this makes the passive diaphragms oscillate and create sound (above and beyond the sound produced by the cone drivers).

Like active drivers, passive radiators typically include a sound radiating surface, or diaphragm, attached via a suspension mechanism to a support structure and/or wall of the speaker enclosure. The radiator surface and suspension mechanism are typically tuned by their mass, flexibility/compliance, and surface area to move in response to compression and rarefaction of air in the enclosure, which results from movement of the active drivers. Movement of the radiator surface causes movement of air outside the enclosure, which causes sound to be generated at the movement frequency.

However, passive radiators are more expensive than sound ports, require more complex configuration due to the method of tuning (typically by adding weight to the radiator surface), and typically require large surface areas (at least two times the surface area of the active driver speakers), thereby requiring a larger enclosure.

Moreover, conventional small-size loudspeaker designs that implement a passive radiator are limited by the surface area of an enclosure and/or by an undesirable radiating direction resulting from a non-ideal placement of the conventional passive radiator. For example, a small-size audio speaker design may use a necessarily small passive radiator in a front baffle in order to fit between active driver speakers, or may use a rear-directed passive radiator in order to take advantage of additional surface area unimpeded by active driver speakers. These configurations are less than ideal, resulting in a deficiency of sound quality.

Another problem with passive radiators is that they greatly amplify sound (usually in the bass frequency range) near their mechanical resonant frequency but do not amplify sound (or they can even attenuate it) at other frequencies. For songs that have large bass notes that do not line up with the resonant frequency (most songs) these notes will not be clearly heard.

### SUMMARY OF THE INVENTION

The present invention is an audio speaker that can dynamically adjust the resonant frequency of its passive radiator so that it lines up with the main bass note frequency (or frequencies) of a given song. For example, as shown in FIG. 1, the frequency spectrum graph of “Dark Horse” by Katy Perry shows a very strong resonance peak at 58 Hz (x axis is in Hz and y axis is in relative dB). The present invention adjusts the stiffness or mass of one or more passive radiators so that the mechanical resonant peak will equal 58 Hz for this particular song.

Typically the speaker of the present invention will receive a bluetooth or other signal (WiFi, analog, etc.) from a phone or other device and delay it (such as on the order of 10 to 100 milliseconds) before it is played so the controller can look ahead and determine the main song bass note (or notes) and then make adjustments to the passive radiator (changing its stiffness, mass or both) so that by the time the main bass note is played the radiator will respond strongly (radiate a high level of sound) to this note.

In general, in one aspect, the present invention features an audio speaker system that includes an active driver, a memory element, a passive radiator having a resonant frequency, and an actuator operable to dynamically adjust the resonant frequency of the passive radiator.

Implementation of the invention can include one or more of the following features:

The active driver can be an electrodynamic driver.

The memory element can be a flash memory element.

The actuator can be operable to vary the mechanical stiffness of the passive radiator.

The actuator can be a piezoelectric actuator.

The actuator can be operable to vary the mass of the passive radiator.

The actuator can be a liquid mass adjustment actuator.

In general, in another aspect, the present invention features a method that includes receiving an audio file in an audio speaker system. The audio speaker system comprises an active driver and a passive radiator that has a dynamically adjustable resonant frequency. The method further includes storing the audio file in a memory element of the audio speaker system. The method further includes transmitting an electrical signal to an active driver in the audio speaker system. The method further includes creating a time delay between the step of receiving the audio file and the step of transmitting the electrical signal to an active driver. The method further includes adjusting the resonant frequency of the passive radiator to control the resonant frequency of the passive radiator.

Implementation of the invention can include one or more of the following features:

The active driver can be an electrodynamic driver.

The memory element can be a flash memory element.

The step of adjusting can vary the mechanical stiffness of the passive radiator.

The step of adjusting can include utilizing a piezoelectric actuator.

The step of adjusting comprises can vary the mass of the passive radiator.

The step of adjusting can include utilizing a liquid mass adjustment actuator.

The method can further include analyzing, during the time delay, at least part of the audio file to determine the resonant frequency that maximizes the average amplitude of multiple main bass notes present in the at least part of the audio file. The step of adjusting can include adjusting the resonant frequency of the passive radiator to the resonant frequency determined during the step of analyzing.

The can further include determining the resonant frequency required for each of main bass notes present in the audio file. The step of adjusting can include adjusting the resonant frequency of the passive radiator toward the resonant frequency determined during the step of analyzing, wherein the step of adjusting corresponds in time to the transmission of the electrical signal to the active drive for each of the main bass notes.

In general, in another aspect, the present invention features a method that includes analyzing a first part of an incoming audio file. The method further includes matching the incoming audio file to a song. The method further includes retrieving parts of the song from a memory module. The method further includes dynamically adjusting a resonant frequency parameter of a passive radiator (of an audio speaker system comprising an active driver and the passive radiator) to enhance the primary bass notes in the song.

Implementation of the invention can include one or more of the following features:

The resonant frequency parameter of the passive radiator can be stiffness, mass, or both.

### DESCRIPTION OF DRAWINGS

FIG. 1 is a frequency spectrum graph generated from a representative song.

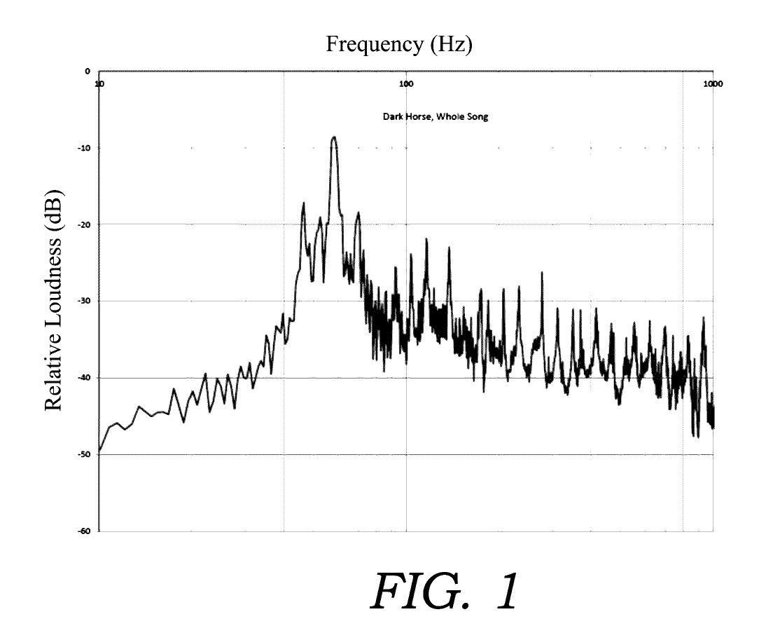

FIG. 2 is an embodiment of an audio speaker having a passive radiator with dynamically adjustable resonant frequency.

FIG. 3 is a frequency spectrum graph generated from another representative song.

FIG. 4 is another embodiment of an audio speaker having a passive radiator with dynamically adjustable resonant frequency.

### DETAILED DESCRIPTION

The present invention relates to audio speakers having one or more passive radiators, and more specifically, audio speakers having passive radiators with dynamically adjustable resonant frequency.

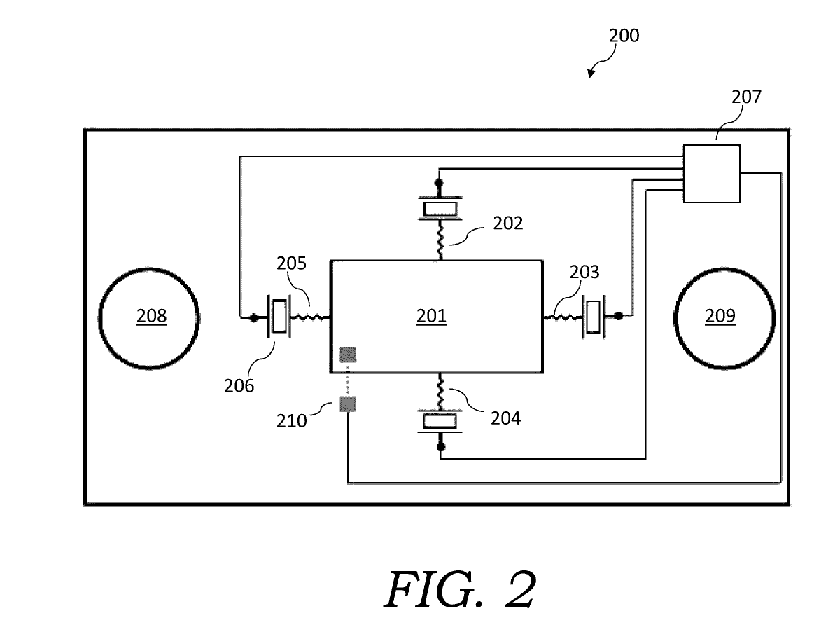

FIG. 2 shows a speaker 200 having four adjustable tension supports 202-205 connected to a passive radiator 201. Preferably there are piezoelectric actuators mechanically connected to each support (such as piezoelectric actuator 206 mechanically connected to adjustable tension support 205) which are in turn electrically connected to a controller 207. Optionally, there may be a position sensor 210 near the passive radiator 201 that provides a position feedback signal back to the controller 207 (so that the controller 207 can make sure the amplitude of the passive radiator 201 is the correct value for a given note of a song file). Increasing the tension of the supports 202-205 (with the respective piezoelectric actuators) will increase the mechanical resonant frequency of the passive radiator 201 and decreasing the tension will lower the resonant frequency. The speaker also has sound transducers 208-209 (such as active driver speakers).

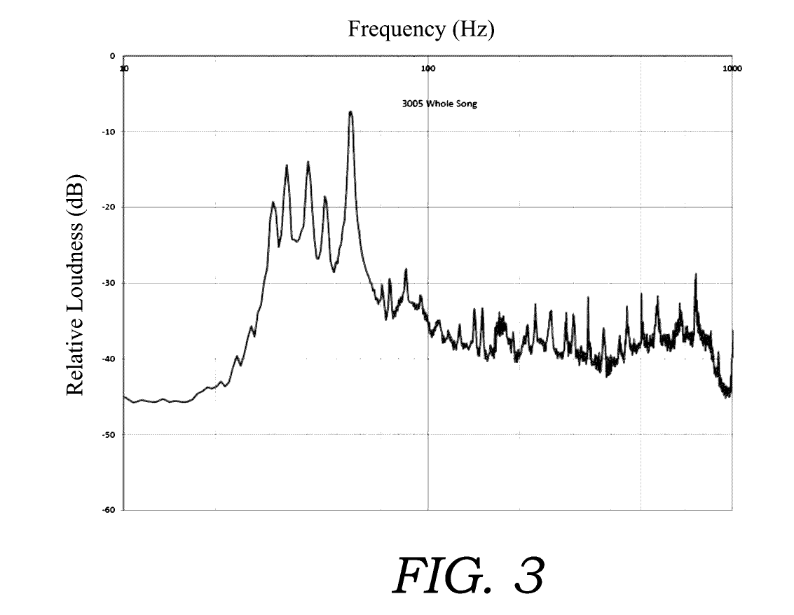

If there are multiple bass notes (like in the attached song graph of “3005” shown in FIG. 3), the controller 207 and actuator (such as piezoelectric actuator 206) can either (a) choose a tension that maximizes the average amplitude of the multiple main bass notes or (b) try to rapidly adjust the tension to optimize each note individually (the time between these notes will determine which of these modes is utilized).

Alternatively, other types of actuators (magnetic, electrostatic, etc.) can be used to adjust the passive radiator support tension. A compliant material such as rubber may be used in conjunction with the tension supports to form a seal between the relatively stiff material of passive radiator 201 and the device housing (to allow the passive radiator 201 to move while keeping unwanted sounds inside of the housing).

Controller 207 may include a flash memory module that stores relevant audio file information (such as the frequency and magnitude of large bass notes) from a large number of songs. For song files that are not initially stored in this module controller 207 can send the relevant parts of song files that are played on the loudspeaker to the memory module for later use. It will take controller 207 just a few seconds to recognize a given song and then retrieve the relevant audio file information from the memory module. Knowing the relevant parts of a song file in advance will allow controller 207 more time to adjust the stiffness of the passive radiator 201.

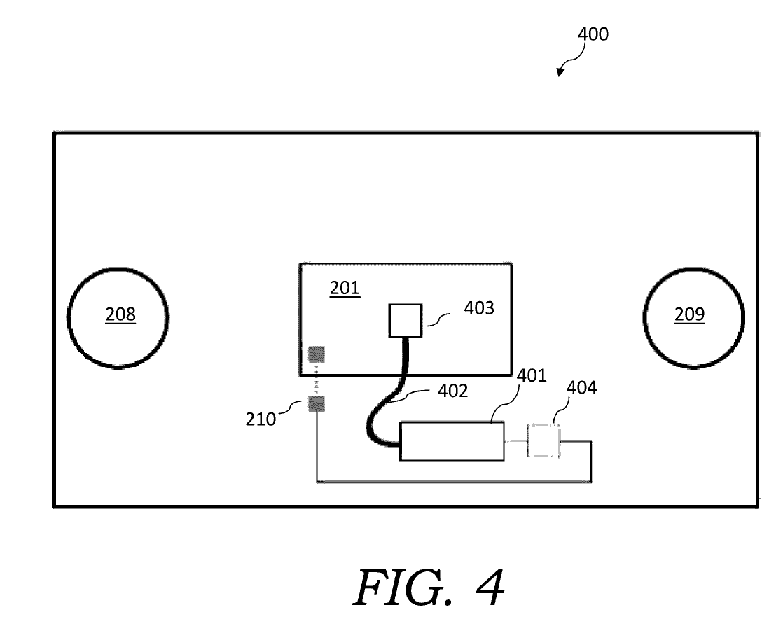

FIG. 4 shows an alternate embodiment of the present invention. Speaker 400 has a variable mass system that can be used to achieve the same end, but with a slower reaction time. Speaker 400 has a liquid pump 401 that forces a liquid through a tube 402 and in or out of a reservoir 403 that is attached to the passive radiator 201. A controller 404 (along with an optional position sensor 210) can determine how much fluid/mass is needed in the reservoir 403 to reach a desired passive-radiator amplitude for a target note within a song.

A number of embodiments of the invention have been described. Nevertheless, it will be understood that various modifications may be made without departing from the spirit and scope of the invention. Accordingly, other embodiments are within the scope of the following claims.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above, but is only limited by the claims which follow, that scope including all equivalents of the subject matter of the claims.

The disclosures of all patents, patent applications, and publications cited herein are hereby incorporated herein by reference in their entirety, to the extent that they provide exemplary, procedural, or other details supplementary to those set forth herein.

What is claimed is:

1. An audio speaker system comprising:
(a) an active driver;
(b) a memory element;
(c) a passive radiator having a resonant frequency; and
(d) an actuator operable to dynamically adjust the resonant frequency of the passive radiator.

2. The audio speaker system of claim 1, wherein the active driver is an electrodynamic driver.

3. The audio speaker system of claim 1, wherein the memory element is a flash memory element.

4. The audio speaker system of claim 1, wherein the actuator is operable to vary the mechanical stiffness of the passive radiator.

5. The audio speaker system of claim 4, wherein the actuator is a piezoelectric actuator.

6. The audio speaker system of claim 1, wherein the actuator is operable to vary the mass of the passive radiator.

7. The audio speaker system of claim 6, wherein the actuator is a liquid mass adjustment actuator.

8. A method comprising:
(a) receiving an audio file in an audio speaker system comprising an active driver and a passive radiator that has a dynamically adjustable resonant frequency;
(b) storing the audio file in a memory element of the audio speaker system;
(c) transmitting an electrical signal to an active driver in the audio speaker system;
(d) creating a time delay between the step of receiving the audio file and the step of transmitting the electrical signal to an active driver; and
(e) adjusting the resonant frequency of the passive radiator to control the resonant frequency of the passive radiator.

9. The method of claim 8, wherein the active driver is an electrodynamic driver.

10. The method of claim 8, wherein the memory element is a flash memory element.

11. The method of claim 1, wherein the step of adjusting comprises varying the mechanical stiffness of the passive radiator.

12. The method of claim 11, wherein the step of adjusting comprises utilizing a piezoelectric actuator.

13. The method of claim 8, wherein the step of adjusting comprises varying the mass of the passive radiator.

14. The method of claim 13, wherein the step of adjusting comprises utilizing a liquid mass adjustment actuator.

15. The method of claim 8, wherein:
(a) the method further comprises analyzing, during the time delay, at least part of the audio file to determine the resonant frequency that maximizes the average amplitude of multiple main bass notes present in the at least part of the audio file; and
(b) the step of adjusting comprises adjusting the resonant frequency of the passive radiator to the resonant frequency determined during the step of analyzing.

16. The method of claim 8, wherein:
(a) the method further comprises determining the resonant frequency required for each of main bass notes present in the audio file; and
(b) the step of adjusting comprises adjusting the resonant frequency of the passive radiator toward the resonant frequency determined during the step of analyzing, wherein the step of adjusting corresponds in time to the transmission of the electrical signal to the active driver for each of the main bass notes.

17. A method comprising:
(a) analyzing a first part of an incoming audio file;
(b) matching the incoming audio file to a song;
(c) retrieving parts of the song from a memory module; and
(d) dynamically adjusting a resonant frequency parameter of a passive radiator of an audio speaker system comprising an active driver and the passive radiator to enhance primary bass notes of the song.

18. The method of claim 17, wherein the resonant frequency parameter of the passive radiator is selected from a group consisting of stiffness, mass, and combinations thereof.
